(19) United States
(12) Patent Application Publication
(10) Pub. No.: US 2024/0291137 A1
(43) Pub. Date: Aug. 29, 2024

(54) ANTENNAS HAVING POWER DIVIDERS INTEGRATED WITH A CALIBRATION BOARD OR A FEED BOARD

(71) Applicant: CommScope Technologies LLC, Claremont, NC (US)

(72) Inventors: Kumara Swamy KASANI, Godavarikhani (IN); Rakesh KALWANI, Margao (IN); Lakshminarayana POLLAYI, Srikakulam (IN); Ligang WU, Suzhou (CN)

(21) Appl. No.: 18/568,416

(22) PCT Filed: May 18, 2022
(86) PCT No.: PCT/US2022/029749

§ 371 Date: Dec. 8, 2023

(30) Foreign Application Priority Data
Jun. 16, 2021 (IN) 202121026922

(51) Int. Cl. H01Q 1/24; H01Q 3/36; H01Q 19/10

(52) U.S. Cl. CPC H01Q 1/246; H01Q 3/36; H01Q 19/10

(57) ABSTRACT

Base station antennas are provided. A base station antenna includes a reflector and radiating elements that are in rows and columns on the reflector. Each of the radiating elements extends forwardly from the reflector. Moreover, the base station antenna includes power dividers that are on a calibration board, or on a feed board, of the base station antenna.

### CROSS-REFERENCE TO RELATED APPLICATION

The present application claims priority to Indian Provisional Patent Application No. 202121026922, filed Jun. 16, 2021, the entire content of which is incorporated herein by reference.

### BACKGROUND

The present invention generally relates to radio communications and, more particularly, to base station antennas for cellular communications systems.

Cellular communications systems are well known in the art. In a cellular communications system, a geographic area is divided into a series of regions or “cells” that are served by respective base stations. Each base station may include one or more base station antennas that are configured to provide two-way radio frequency (“RF”) communications with subscribers that are within the cell served by the base station. In many cases, each base station is divided into “sectors.” In one common configuration, a hexagonally-shaped cell is divided into three 120° sectors in the azimuth plane, and each sector is served by one or more base station antennas that have an azimuth Half Power Beamwidth (“HPBW”) of approximately 65°. Typically, the base station antennas are mounted on a tower or other raised structure, with the radiation patterns that are generated by the base station antennas directed outwardly. Base station antennas are often implemented as linear or planar phased arrays of radiating elements.

To increase capacity, base station antennas that include beamforming arrays and/or that are configured to operate with multi-input-multi-output (“MIMO”) radios have been introduced in recent years. A beamforming array refers to an antenna array that includes multiple columns of radiating elements. Beamforming arrays can generate antenna beams having reduced (narrower) beamwidths in, for example, the horizontal or “azimuth” plane, which increases the directivity or “gain” of the antenna, thereby increasing the supportable throughput. MIMO refers to a communication technique in which a data stream is broken into pieces that are simultaneously transmitted using certain coding techniques over multiple relatively uncorrelated transmission paths between a transmitting station and a receiving station. Multi-column antenna arrays may be used for MIMO transmissions, where each column in the array may be connected to a port of a MIMO radio and used to transmit/receive one of the multiple data streams. In practice, as orthogonal polarizations tend to be highly uncorrelated, the radiating elements in a MIMO array are typically implemented as dual-polarized radiating elements, allowing each column in the MIMO array to be connected to two ports on the radio (where the first port is connected to the first-polarization radiators of the radiating elements in the column, and the second port is connected to the second-polarization radiators of the radiating elements in the column). This technique can effectively halve the number of columns of radiating elements required, as each physical column of the array contains two independent columns of radiators.

MIMO and beamforming techniques can also be combined. For example, so-called 8-Transmit/8-Receive (“8T8R”) radios (which include eight radio ports) are now routinely connected to antenna arrays that include four columns of dual-polarized radiating elements that are configured to form a single antenna beam per polarization within a sector The two polarizations may be used to implement 2xMIMO communications for each antenna beam. These beamforming antennas are typically used for time division duplex (“TDD”) communications and may generate a single antenna beam during each individual time slot of the TDD communication scheme. Likewise, 16-Transmit/16-Receive (“16T16R”) radios (which include sixteen radio ports) are known in the art that are connected to antenna arrays that include eight columns of dual-polarized radiating elements that are configured to form a single antenna beam at a time within a sector. The 16T16R solutions provide higher gain and less interference (and hence support higher data throughput) as compared to the 8T8R solution, but also require a larger array on the antenna and a much more expensive 16T16R radio, which can significantly increase cost.

A radio may adjust the amplitude and phase of sub-components of an RF signal that are passed to each RF port so that columns of radiating elements work together to form a more-focused, higher-gain antenna beam that has a narrowed beamwidth in the azimuth and/or elevation planes. In some cases, these beamforming antennas may be used to form two or more static antenna beams, where each antenna beam has a smaller beamwidth in the azimuth plane. This approach may be used to perform so-called “sector splitting” where a 120° sector can be split into two, three, or even more smaller sub-sectors, and the beamforming antenna may be configured to generate a separate antenna beam for each sub-sector. Beamforming antennas are also available that are capable of forming narrow antenna beams that are sometimes referred to as “pencil beams” that can be pointed at specific users or closely clustered groups of users. These antennas can generate different pencil beams on a time-slot by time-slot basis so that very-high-gain antenna beams can be electronically steered throughout a sector during different time slots to provide coverage to the users throughout the sector.

Unfortunately, the relative amplitude and phases applied by the radio to the sub-components of the RF signal that are passed to each column of a beamforming antenna may not be maintained as the sub-components of the RF signal are passed from the radio to a high-power amplifier and then on to the base station antenna. If the relative amplitudes and phases change, then the resulting antenna beam will typically exhibit lower antenna gains in desired directions and higher antenna gains in undesired directions, resulting in degraded performance. Variations in the relative amplitudes and phases may arise, for example, because of non-linearities in the amplifiers that are used to amplify the respective transmitted and received signals, differences in the lengths of the cabling connections between the different radio ports and respective RF ports on the antenna, variations in temperature, and the like. While some of the causes for the amplitude and phase variations may tend to be static (i.e., they do not change over time), others may be dynamic, and hence more difficult to compensate.

To reduce the impact of the above-discussed amplitude and phase variations, base station antennas may include a calibration circuit that samples each sub-component of an RF signal and passes these samples back to the radio. The calibration circuit may comprise a plurality of directional couplers, each of which is configured to tap RF energy from respective RF transmission paths that extend between the RF ports and the respective columns of radiating elements, as well as a calibration combiner that is used to combine the RF energy tapped off of each of these RF transmission paths. The output of the calibration combiner is coupled to a calibration port on the antenna, which in turn is coupled back to the radio. The radio may use the samples of each sub-component of the RF signal to determine the relative amplitude and/or phase variations along each transmission path, and may then adjust the applied amplitude and phase weights to account for these variations.

### SUMMARY

Pursuant to embodiments of the present invention, a base station antenna may include a reflector and a plurality of radiating elements that are in a plurality of rows and columns on the reflector. Each of the radiating elements may extend forwardly from a first side of the reflector. The base station antenna may include a calibration port. Moreover, the base station antenna may include a calibration board on a second side of the reflector that is opposite the first side. The calibration board may include a plurality of power dividers that are each coupled to the calibration port. A first of the power dividers may be coupled to a pair of the columns.

In some embodiments, the calibration board may include a plurality of directional couplers that are coupled to the power dividers without any cables therebetween. A first of the directional couplers may be coupled to an input of the first of the power dividers. Moreover, the directional couplers and the power dividers may be traces of the calibration board.

According to some embodiments, the pair of the columns may be a non-adjacent pair of the columns. Moreover, the base station antenna may include a plurality of phase shifters on the second side of the reflector, and the first of the power dividers may be coupled to the pair of the columns via a pair of the phase shifters.

In some embodiments, the first of the power dividers may be configured to provide a plurality of unequal power outputs. Moreover, the base station antenna may include a first-polarization RF port that is coupled to the pair of the columns via the first of the power dividers, and a second-polarization RF port that is coupled to the pair of the columns via a second of the power dividers.

A base station antenna, according to some embodiments, may include a reflector. The base station antenna may include a plurality of radiating elements that are in a plurality of rows and columns on the reflector. Each of the radiating elements may extend forwardly from a first side of the reflector. The base station antenna may include a plurality of phase shifters. The base station antenna may include a printed circuit board (“PCB”) on a second side of the reflector that is opposite the first side. The PCB may include a plurality of power dividers that are coupled between the phase shifters and the columns. Moreover, a first of the power dividers may be coupled between a first of the phase shifters and a pair of the columns.

In some embodiments, the PCB may be a first PCB that is coupled to a first of the rows, and the base station antenna may include a second PCB on the second side of the reflector. The second PCB may include a plurality of power dividers that are coupled to a second of the rows.

According to some embodiments, the base station antenna may include a third PCB on the second side of the reflector. The third PCB may include a plurality of power dividers that are coupled to a third of the rows.

In some embodiments, the base station antenna may include a fourth PCB on the second side of the reflector. The fourth PCB may include a plurality of power dividers that are coupled to a fourth of the rows. Moreover, the base station antenna may include a fifth PCB on the second side of the reflector. The fifth PCB may include a plurality of power dividers that are coupled to a fifth of the rows.

According to some embodiments, each row may include a plurality of feed-board PCBs, and each of the feed-board PCBs may have one or more of the radiating elements thereon. Moreover, the first of the power dividers may be configured to provide a plurality of unequal power outputs.

In some embodiments, the phase shifters may include first-polarization phase shifters and second-polarization phase shifters on the second side of the reflector. The first of the phase shifters may be a first of the first-polarization phase shifters. A second of the power dividers may be coupled between the pair of the columns and a first of the second-polarization phase shifters. Moreover, a total number of the phase shifters may be equal to a total number of the columns.

A base station antenna, according to some embodiments, may include a reflector and a PCB on a first side of the reflector. The base station antenna may include a plurality of radiating elements that are in a plurality of rows and columns on the PCB. Each of the radiating elements may extend forwardly from the PCB. Moreover, the base station antenna may include a plurality of phase shifters. The PCB may include a plurality of power dividers that are coupled between the phase shifters and the columns. A first of the power dividers may be coupled between a first of the phase shifters and a pair of the columns.

In some embodiments, the phase shifters may include first-polarization phase shifters and second-polarization phase shifters on a second side of the reflector that is opposite the first side. The first of the phase shifters may be a first of the first-polarization phase shifters. Moreover, a second of the power dividers may be coupled between the pair of the columns and a first of the second-polarization phase shifters. A total number of the phase shifters may be equal to a total number of the columns.

According to some embodiments, the rows and columns may include five rows and eight columns, respectively, that are on the PCB. The first of the power dividers may be configured to provide a plurality of unequal power outputs. Moreover, a second of the power dividers may be configured to divide power at a ratio different from that of the first of the power dividers.

### BRIEF DESCRIPTION OF THE DRAWINGS

FIG. 1A is a schematic front view of an antenna system that includes an 8T8R radio, a coupling circuit, and an antenna array that includes eight columns of dual-polarized radiating elements.

FIG. 1B is a schematic diagram illustrating a coupling circuit that can be used to couple the 8T8R radio of FIG. 1A to the eight-column antenna array of FIG. 1A.

FIG. 1C is a schematic diagram illustrating another coupling circuit that can be used to couple the 8T8R radio of FIG. 1A to the eight-column antenna array of FIG. 1A.

FIG. 1D is a front view of an eight-column antenna array similar to that of FIG. 1A.

FIG. 2A is a rear view of an antenna according to embodiments of the present invention.

FIG. 2B is a schematic block diagram of the calibration board of FIG. 2A.

FIG. 2C is a plan view illustrating traces of the calibration board of FIG. 2A.

FIG. 2D is a schematic diagram illustrating connections between the power dividers of FIG. 2B and columns of radiating elements.

FIG. 2E is a schematic block diagram illustrating a stack of the phase shifters of FIG. 2A.

FIG. 3A is a schematic block diagram of an antenna according to other embodiments of the present invention.

FIG. 3B is a schematic block diagram of one of the sub-array power-divider boards of FIG. 3A.

FIG. 4A is a schematic block diagram of an antenna according to further embodiments of the present invention.

FIG. 4B is a schematic block diagram of the power dividers and columns of radiating elements of FIG. 4A on a shared board.

### DETAILED DESCRIPTION

Pursuant to embodiments of the present invention, antennas are provided that include antenna arrays that have multiple columns of radiating elements, where at least some of the columns are coupled to the same RF ports of a radio (herein “radio signal ports”). This allows the antenna systems to provide improved antenna patterns and higher gains while using relatively inexpensive radios. The radiating elements may be dual-polarized radiating elements so that the multi-column antenna array may generate multiple antenna beams at each polarization. In some embodiments, pairs of the columns may be coupled to respective power dividers that are integrated with a calibration board, thus improving antenna performance and reducing cost relative to calibration boards that are coupled to power dividers via cables and solder transitions. In other embodiments, power dividers may be integrated with a feed board, thus reducing the total number of phase shifters in an antenna.

Embodiments of the present invention will now be discussed in greater detail with reference to the attached figures.

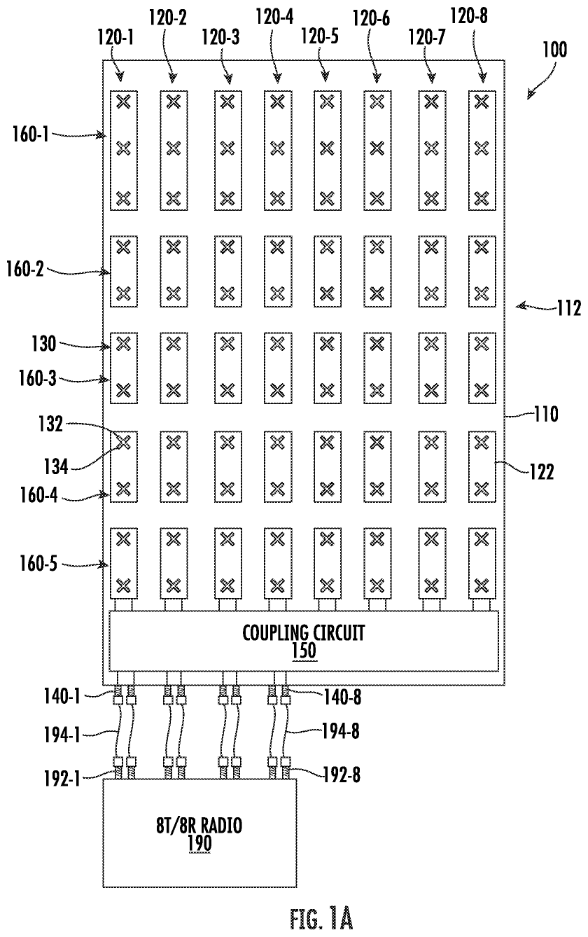

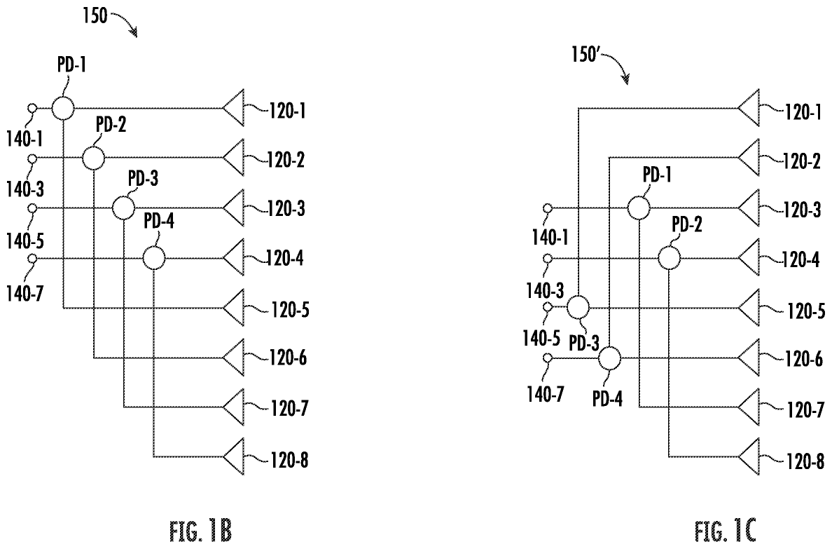

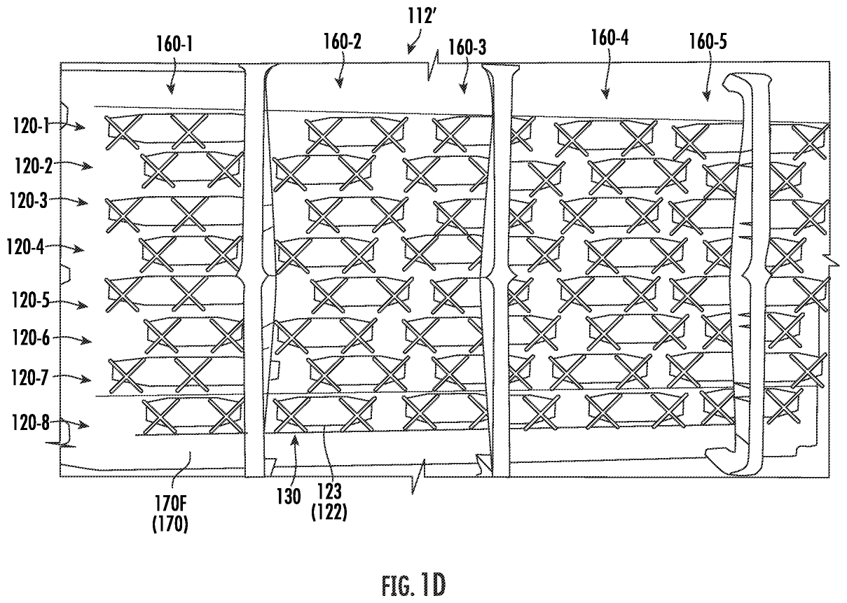

FIG. 1A is a schematic front view of an antenna system 100 that includes an 8T8R radio 190, a coupling circuit 150, and an antenna array 112 that includes eight columns 120-1 through 120-8 of dual-polarized radiating elements 130. Each radiating element 130 may comprise, for example, a crossed-dipole radiating element that includes a first dipole radiator 132 and a second dipole radiator 134 that crosses/intersects the first dipole radiator 132. The dipole radiators 132 and 134 each have two dipole “arms.” Each column 120 includes one or more groups 122 (e.g., one or more sub-array s) of radiating elements 130. As shown in FIG. 1A, the antenna array 112 includes five rows 160-1 through 160-5 of the groups 122.

The array of columns 120 may be inside a radome of the antenna 110. For simplicity of illustration, the radome is omitted from view in FIG. 1A. The antenna 110 may include RF ports 140-1 through 140-8, which may also be referred to herein as “connectors” or “antenna signal ports,” that are coupled (e.g., electrically connected) to the columns 120. As is further shown in FIG. 1A, the antenna signal ports 140 are also coupled to respective radio signal ports 192 of the radio 190 by respective RF transmission lines 194-1 through 194-8, such as coaxial cables. For example, the radio 190 may be a TDD beamforming radio for a cellular base station, and the antenna 110 and the radio 190 may be located at (e.g., may be components of) a cellular base station.

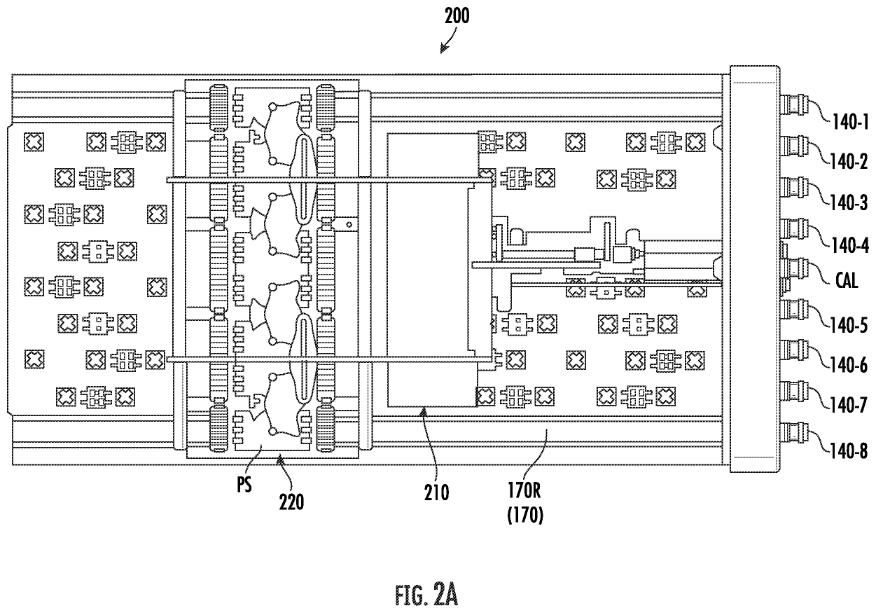

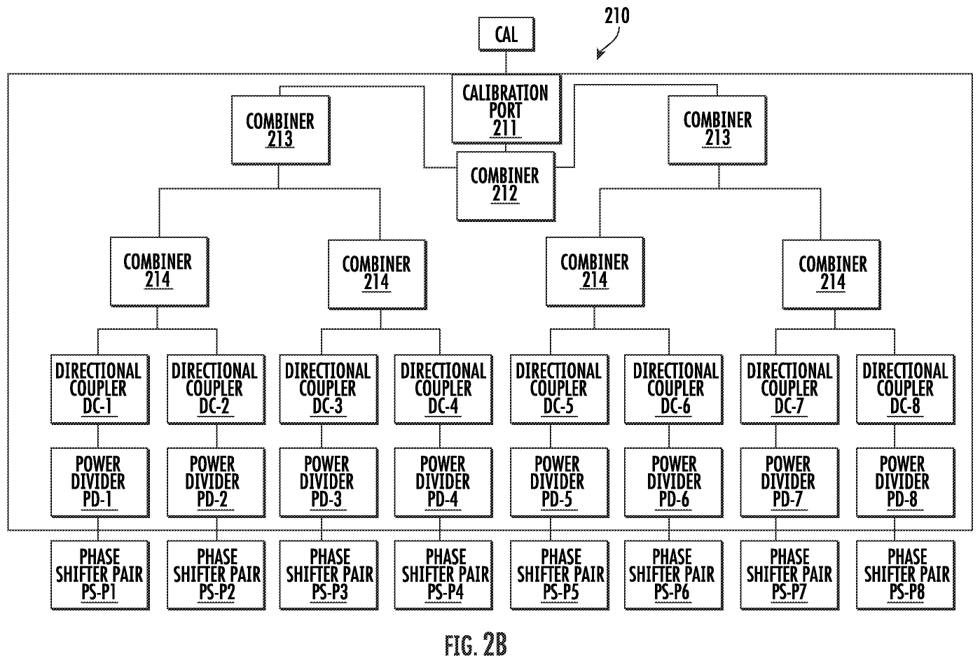

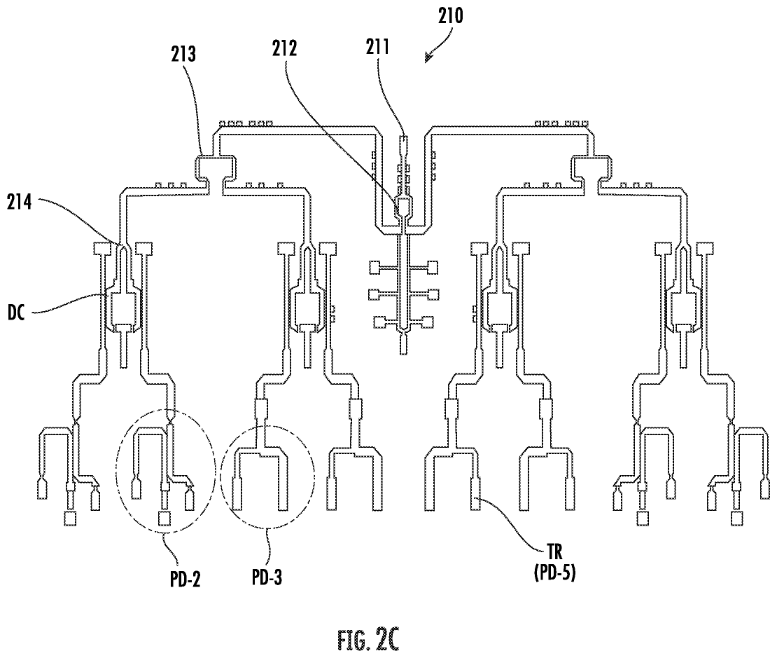

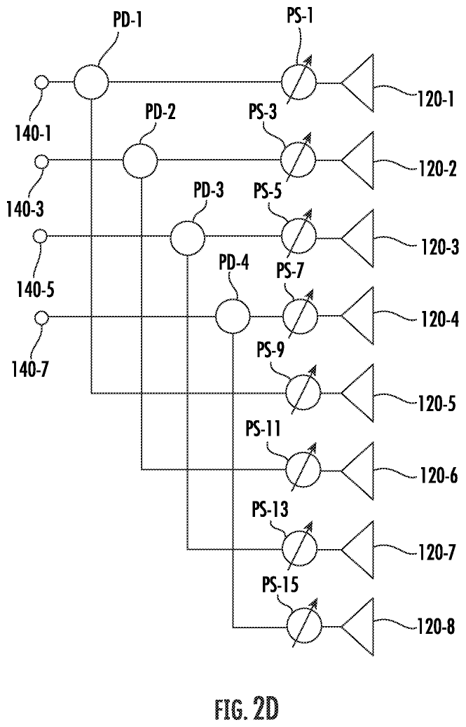

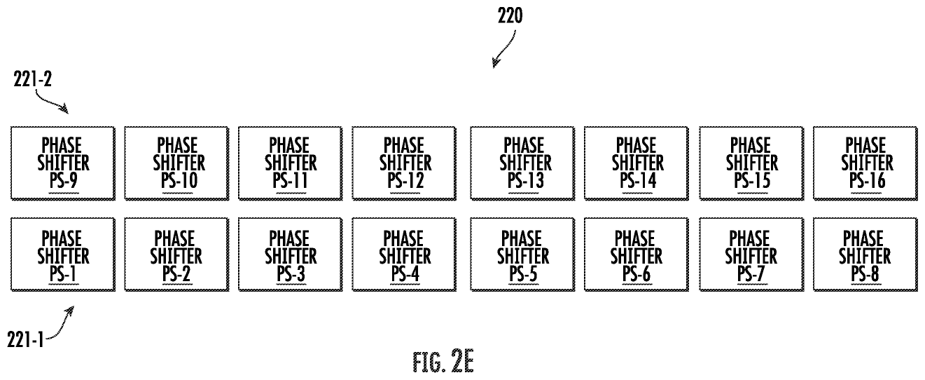

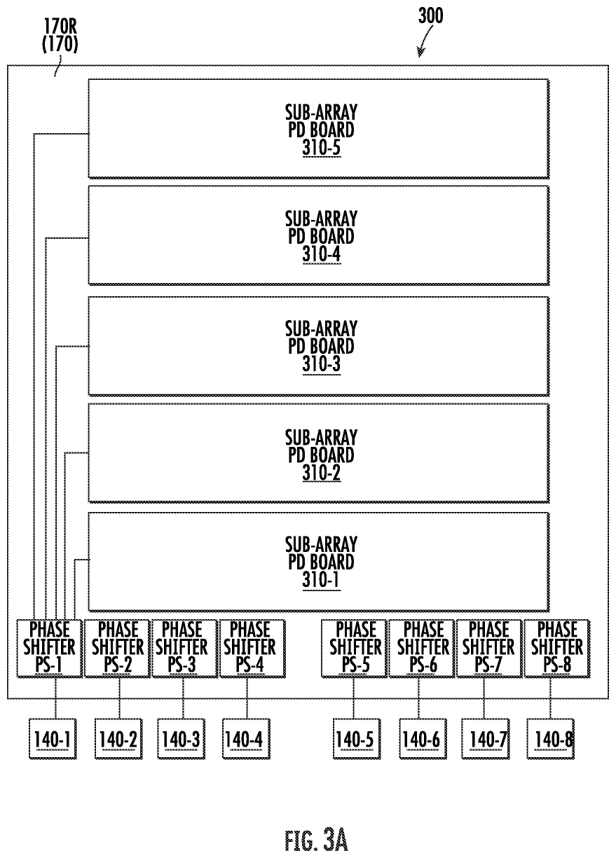

Because the radio 190 is shown as an 8T8R radio, it includes eight RF ports 192-1 through 192-8 that pass RF communication signals between the internal components of the radio 190 and the antenna array 112. These ports 192 may also be referred to herein as “radio signal ports.” For example, four of the radio signal ports 192 may be first-polarization ports and another four of the radio signal ports 192 may be second-polarization ports, where the first and second polarizations are different polarizations. The radio 190 may also include one or more calibration ports CAL (FIG. 2A) that are not radio signal ports, but instead are ports that may be used in calibrating the internal circuitry of the radio 190 to account for amplitude and phase differences between the RF signal paths external to the radio 190.

FIG. 1B is a schematic diagram illustrating a coupling circuit 150 that can be used to couple the 8T8R radio 190 of FIG. 1A to the eight-column antenna array 112 of FIG. 1A. The coupling circuit 150 may include four power dividers PD-1 through PD-4. Each of the power dividers PD may electrically connect a respective radio signal port 192 of the radio 190 (via a respective antenna signal port 140 of the antenna 110) to a pair of columns 120.

The first power divider PD-1 connects a first antenna signal port 140-1 of the antenna 110 to both the first column 120-1 and the fifth column 120-5. The second power divider PD-2 connects a third antenna signal port 140-3 of the antenna 110 to both the second column 120-2 and the sixth column 120-6. The third power divider PD-3 connects a fifth antenna signal port 140-5 of the antenna 110 to both the third column 120-3 and the seventh column 120-7. Similarly, the fourth power divider PD-4 connects a seventh antenna signal port 140-7 of the antenna 110 to both the fourth column 120-4 and the eighth column 120-8. The antenna signal ports 140-1, 140-3, 140-5, and 140-7 may be first-polarization ports. For simplicity of illustration, second-polarization ports 140-2, 140-4, 140-6, and 140-8 are omitted from view in FIG. 1B. An identical circuit including another four power dividers PD may connect the second-polarization ports 140-2, 140-4, 140-6, and 140-8 to the eight columns 120 of antenna array 112. The coupling circuit 150 may thus include a total of eight power dividers PD.

FIG. 1C is a schematic diagram illustrating another coupling circuit 150′ that can be used to couple the 8T8R radio 190 of FIG. 1A to the eight-column antenna array 112 of FIG. 1A. The first power divider PD-1 connects the first antenna signal port 140-1 of the antenna 110 to both the third column 120-3 and the seventh column 120-7. The second power divider PD-2 connects the third antenna signal port 140-3 to both the fourth column 120-4 and the eighth column 120-8. The third power divider PD-3 connects the fifth antenna signal port 140-5 to both the first column 120-1 and the fifth column 120-5. Similarly, the fourth power divider PD-4 connects the seventh antenna signal port 140-7 to both the second column 120-2 and the sixth column 120-6.

Accordingly, as shown in FIGS. 1B and 1C, the power dividers PD can feed various combinations of non-adjacent columns 120. As used herein with respect to columns 120, the term “non-adjacent” refers to two columns 120 that have least one other column 120 therebetween. For example, FIGS. 1B and 1C show that each commonly-coupled pair of columns 120 has three columns 120 therebetween. Accordingly, the same distance can separate each commonly-coupled pair.

Though example antennas discussed herein have eight columns 120 and five rows 160, antennas according to the present invention may, in some embodiments, include more or fewer columns 120 and/or rows 160. Likewise, the 8T8R radio 190 is merely an example, and antennas according to the present invention may be coupled to a radio that has more or fewer ports 192 than the 8T8R radio 190. Other examples of antennas in which multiple columns (and/or multiple rows) of radiating elements share a radio port (as well as an antenna port coupled thereto) are discussed in U.S. patent application Ser. No. 17/149,187, filed on Jan. 14, 2021, the entire content of which is incorporated herein by reference.

FIG. 1D is a front view of an antenna array 112′ that is similar to the antenna array 112 of the antenna 110 of FIG. 1A. Groups 122 of two or three radiating elements 130 of the antenna array 112′ may be on respective PCBs 123. Accordingly, each row 160 shown in FIG. 1D includes eight PCBs 123, and each column 120 includes five PCBs 123. Moreover, the PCBs 123 are all on a front surface 170F of a reflector 170. The radiating elements 130 of the PCBs 123 thus extend forwardly from the front surface 170F.

FIG. 2A is a rear view of an antenna 200 according to embodiments of the present invention. As shown in FIG. 2A, the antenna 200 includes a calibration board 210, as well as a group 220 of phase shifters PS, on a rear surface 170R of a reflector 170. The rear surface 170R is opposite a front surface 170F (FIG. 1D) of the reflector 170. The surfaces 170R, 170F may thus also be referred to herein as opposite “sides” of the reflector 170. In some embodiments, the front side of the antenna 200 may include the eight columns 120-1 through 120-8 and five rows 160-1 through 160-5 of radiating elements 130 that are shown in the antenna array 112′ of FIG. 1D. As shown in FIG. 2A, the antenna 200 also includes a calibration port CAL that is coupled to calibration board 210.

FIG. 2B is a schematic block diagram of the calibration board 210 of FIG. 2A. The calibration board 210 includes eight power dividers PD-1 through PD-8 that are coupled to inputs of the phase shifters PS of the antenna 200. The calibration board 210 also includes a calibration port 211 that couples the calibration board 210 to the calibration port CAL of the antenna 200. Moreover, the calibration board 210 includes eight directional couplers DC-1 through DC-8 that are coupled to inputs of the power dividers PD-1 through PD-8, respectively. Pairs of the directional couplers DC are each coupled to a respective combiner 214 that combines the outputs of its coupler pair. The combiners 214 are coupled to the calibration port 211 via two further tiers of combiners 212, 213. Examples of calibration circuits having combiners and directional couplers are discussed in U.S. Pat. No. 10,812,200, the entire content of which is incorporated herein by reference.

Each power divider PD feeds power to two phase shifters PS of the antenna 200. Accordingly, FIG. 2B shows that the power dividers PD-1 through PD-8 are coupled to phase shifter pairs PS-P1 through PS-P8, respectively. In some embodiments, the phase shifter pairs PS-P1 through PS-P4 include eight first-polarization phase shifters PS and the phase shifter pairs PS-P5 through PS-P8 include eight second-polarization phase shifters PS, where the first and second polarizations are different polarizations.

For simplicity of illustration, connections between RF ports 140 (FIG. 2A) and the phase shifters PS are omitted from view in FIG. 2B. It will be understood, however, that the directional couplers DC are adjacent (e.g., in parallel with), and configured to tap RF energy from, respective RF transmission paths that extend between the ports 140 and respective columns 120 of radiating elements 130 (FIG. 1A).

FIG. 2C is a plan view illustrating traces TR of the calibration board 210 of FIG. 2A. For example, the calibration board 210 may be a PCB having the traces TR on a main surface thereof. In some embodiments, the power dividers PD, the directional couplers DC, the combiners 212-214, and the calibration port 211 may each be implemented as traces TR on the calibration board 210.

In some embodiments, the power dividers PD may not divide power equally. As an example, inner power dividers PD-3 through PD-6 may divide power at a ratio different from that of outer power dividers PD-1, PD-2, PD-7, and PD-8. For example, each of the outer power dividers PD-1, PD-2, PD-7, and PD-8 may provide a plurality of unequal power outputs, whereas each of the inner power dividers PD-3 through PD-6 may provide a plurality of equal (or substantially equal) power outputs. Moreover, the traces TR of the inner power dividers PD-3 through PD-6 may, in some embodiments, have shapes/patterns different from the traces TR of the outer power dividers PD-1, PD-2, PD-7, and PD-8.

FIG. 2D is a schematic diagram illustrating connections between the power dividers PD of FIG. 2B and columns 120 of radiating elements 130 (FIG. 1A). As shown in FIG. 2D, the first power divider PD-1 is coupled to the non-adjacent columns 120-1 and 120-5 via the phase shifters PS-1 and PS-9, respectively. The second power divider PD-2 is coupled to the non-adjacent columns 120-2 and 120-6 via the phase shifters PS-3 and PS-11, respectively. The third power divider PD-3 is coupled to the non-adjacent columns 120-3 and 120-7 via the phase shifters PS-5 and PS-13, respectively. The fourth power divider PD-4 is coupled to the non-adjacent columns 120-4 and 120-8 via the phase shifters PS-7 and PS-15, respectively. The power dividers PD-1, PD-2, PD-3, and PD-4 are coupled between the ports 140-1, 140-3, 140-5, and 140-7, respectively, and the phase shifters PS.

For simplicity of illustration, only one polarization is shown and combiners 212-214 (FIG. 2B) and directional couplers DC (FIG. 2B) are omitted from view in FIG. 2D. For example, the ports 140-1, 140-3, 140-5, and 140-7 that are shown in FIG. 2D may be first-polarization ports. The ports 140-2, 140-4, 140-6, and 140-8 (FIG. 2A), which are omitted from view in FIG. 2D, may be second-polarization ports that are similarly coupled to the columns 120-1 through 120-8 via phase shifters PS-2, PS-4, PS-6, PS-8, PS-10, PS-12, PS-14, and PS-16 (FIG. 2E). For example, the fifth power divider PD-5 (FIG. 2B) may be coupled to the non-adjacent columns 120-1 and 120-5 via the phase shifters PS-2 and PS-10, respectively. The sixth power divider PD-6 (FIG. 2B) may be coupled to the non-adjacent columns 120-2 and 120-6 via the phase shifters PS-4 and PS-12, respectively. The seventh power divider PD-7 (FIG. 2B) may be coupled to the non-adjacent columns 120-3 and 120-7 via the phase shifters PS-6 and PS-14, respectively. The eighth power divider PD-8 (FIG. 2B) may be coupled to the non-adjacent columns 120-4 and 120-8 via the phase shifters PS-8 and PS-16, respectively. The power dividers PD-5, PD-6, PD-7, and PD-8 are coupled between the ports 140-2, 140-4, 140-6, and 140-8, respectively, and the phase shifters PS.

The power dividers PD-1, PD-2, PD-3, and PD-4 are not limited to the connections to the columns 120 that are shown in FIG. 2D. For example, the power dividers PD-1, PD-2. PD-3, and PD-4 may alternatively be coupled to the respective pairs of columns 120 that are shown in FIG. 1C. Accordingly, the first power divider PD-1 may be coupled to the non-adjacent columns 120-3 and 120-7 via the phase shifters PS-5 and PS-13, respectively. The second power divider PD-2 may be coupled to the non-adjacent columns 120-4 and 120-8 via the phase shifters PS-7 and PS-15, respectively. The third power divider PD-3 may be coupled to the non-adjacent columns 120-1 and 120-5 via the phase shifters PS-1 and PS-9, respectively. The fourth power divider PD-4 may be coupled to the non-adjacent columns 120-2 and 120-6 via the phase shifters PS-3 and PS-11, respectively. Likewise, the power dividers PD-5, PD-6, PD-7, and PD-8 may be coupled to the pairs of columns 120 that the power dividers PD-1, PD-2, PD-3, and PD-4, respectively, shown in FIG. 1C are coupled to.

FIG. 2E is a schematic block diagram illustrating a stack of the phase shifters PS of FIG. 2A. The stack includes a total of sixteen phase shifters PS-1 through PS-16 of the group 220 in a first layer 221-1 and a second layer 221-2. The first layer 221-1 is between the second layer 221-2 and the rear surface 170R (FIG. 2A) of the reflector 170 (FIG. 2A). Moreover, though the phase shifters PS-1 through PS-8 are shown in the first layer 221-1 and the phase shifters PS-9 through PS-16 are shown in the second layer 221-2, the phase shifters PS may be in a different order in the layers 221. For example, the first layer 221-1 may include the phase shifters PS-1, PS-3, PS-5, PS-7, PS-9, PS-11, PS-13, PS-15, and PS-17, and the second layer 221-2 may include the phase shifters PS-2, PS-4, PS-6, PS-8, PS-10, PS-12, PS-14, PS-16, and PS-18.

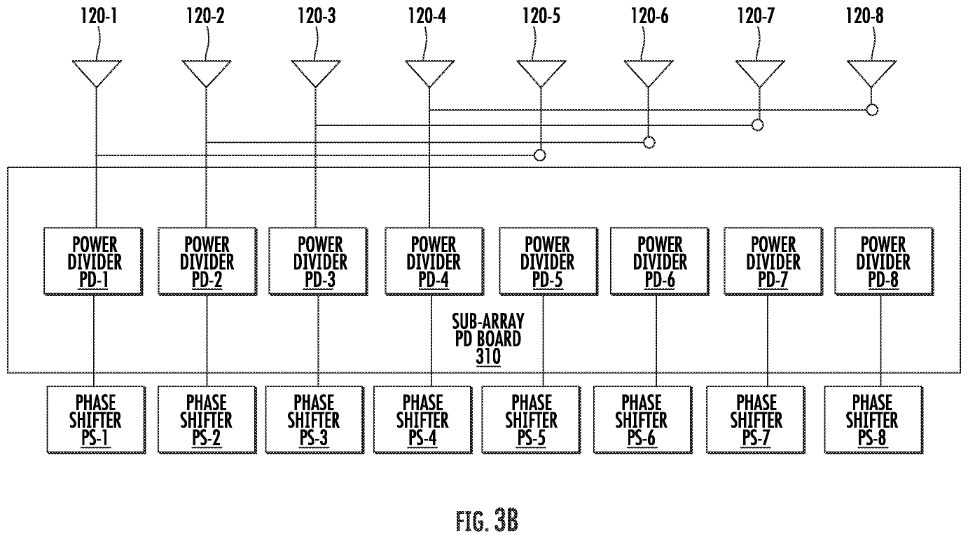

FIG. 3A is a schematic block diagram of an antenna 300 according to other embodiments of the present invention. The antenna 300 includes five sub-array power-divider boards 310-1 through 310-5. Each board 310 is coupled between (i) a respective row 160 of groups 122 of radiating elements 130 (FIG. 1D) and (ii) a plurality of phase shifters PS-1 through PS-8. Specifically, each of the phase shifters PS-1 through PS-8 is coupled to each of the boards 310-1 through 310-5. Accordingly, as shown in FIG. 3A, the first phase shifter PS-1 has five outputs that are coupled to the five boards 310-1 through 310-5, respectively. For simplicity of illustration, similar connections between five outputs of each of the second through eighth phase shifters PS-2 through PS-8 and the five boards 310-1 through 310-5, respectively, are omitted from view in FIG. 3A.

The boards 310-1 through 310-5 are each on the rear surface 170R of a reflector 170 of the antenna 300. The phase shifters PS-1 through PS-8, which may also be on the rear surface 170R, are coupled between ports 140-1 through 140-8, respectively, of the antenna 300 and the boards 310-1 through 310-5.

FIG. 3B is a schematic block diagram of one of the sub-array power-divider boards 310 of FIG. 3A. As shown in FIG. 3B, the board 310 includes eight power dividers PD-1 through PD-8. The boards 310-1 through 310-5 thus collectively include forty power dividers PD. Each power divider PD is coupled between a phase shifter PS and a pair of groups 122 of radiating elements 130 (FIG. 1D) of a pair of columns 120. Specifically, each phase shifter PS has five outputs that are coupled to power dividers PD of the five boards 310-1 through 310-5, respectively. Moreover, as shown in FIG. 3B, the first power divider PD-1 is coupled to the non-adjacent columns 120-1 and 120-5, the second power divider PD-2 is coupled to the non-adjacent columns 120-2 and 120-6, the third power divider PD-3 is coupled to the non-adjacent columns 120-3 and 120-7, and the fourth power divider PD-4 is coupled to the non-adjacent columns 120-4 and 120-8.

For simplicity of illustration, outputs of the phase shifters PS-1 through PS-8 to the four other boards 310, as well as connections from the fifth through eighth power dividers PD-5 through PD-8, are omitted from view in FIG. 3B. For example, the power dividers PD-1 through PD-4 may be four first-polarization power dividers PD and the power dividers PD-5 through PD-8 may be four second-polarization power dividers PD, where the first and second polarizations are different polarizations. Accordingly, the fifth power divider PD-5 may, like the first power divider PD-1, be coupled to the non-adjacent columns 120-1 and 120-5. The sixth, seventh, and eighth power dividers PD-6, PD-7, and PD-8 may, likewise, be coupled to the same pairs of non-adjacent columns 120 that the second, third, and fourth power dividers PD-2, PD-3, and PD-4, respectively, are coupled to.

Because the power dividers PD are coupled between the phase shifters PS and the columns 120, the antenna 300 may have a total of eight phase shifters PS. The antenna 300 may thus have half as many phase shifters PS as the antenna 200 of FIG. 2B. Accordingly, coupling the power dividers PD to outputs, rather than inputs, of the phase shifters PS can reduce the total number of phase shifters PS.

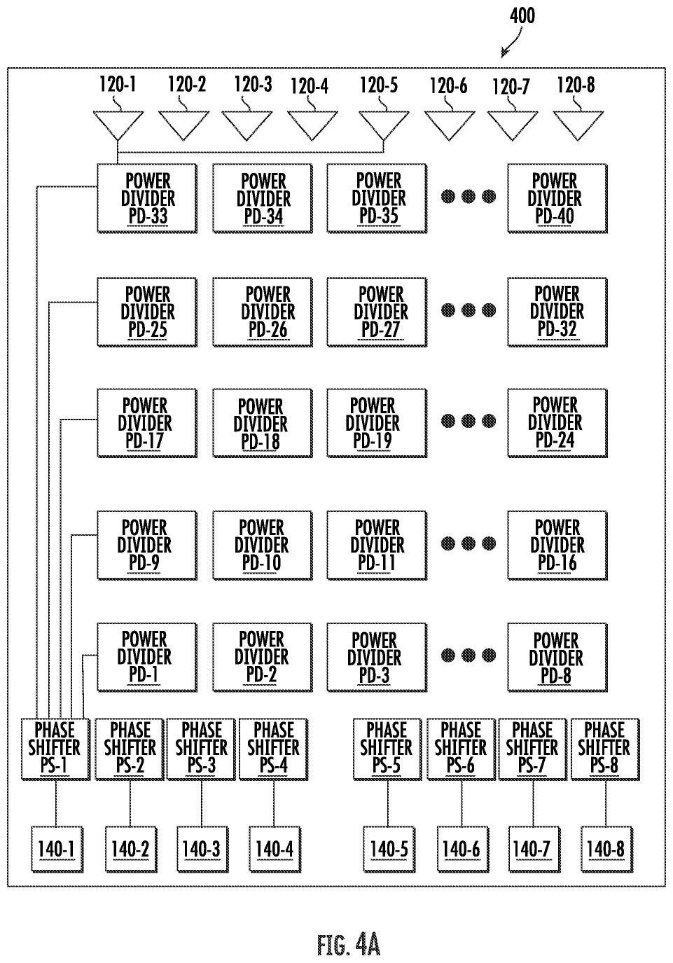

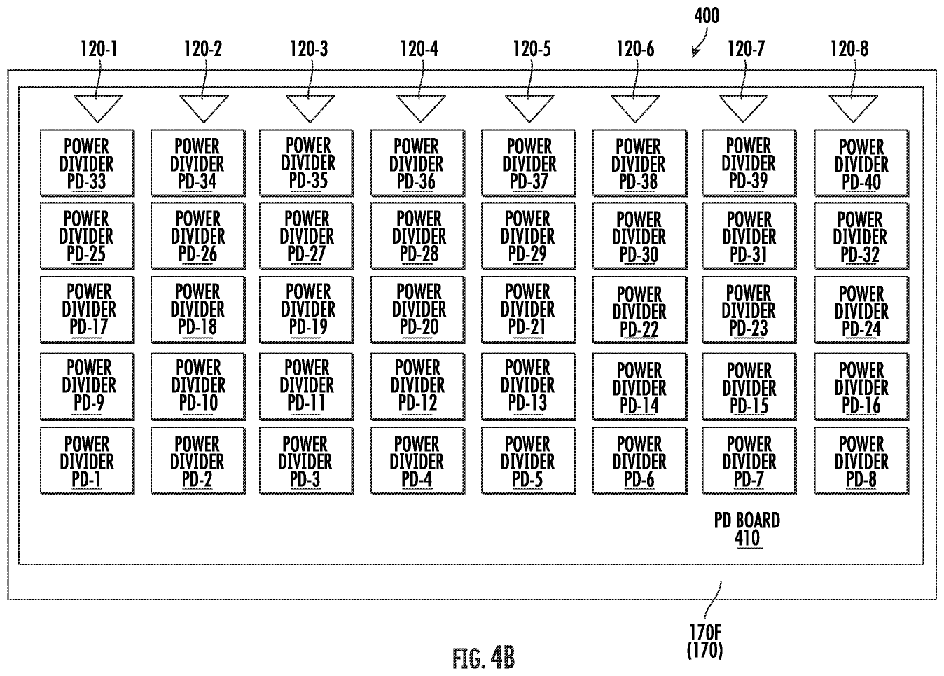

FIG. 4A is a schematic block diagram of an antenna 400 according to further embodiments of the present invention. The antenna 400, like the antenna 300 of FIG. 3A, couples its power dividers PD between eight phase shifters PS-1 through PS-8 and eight columns 120 of radiating elements 130 (FIG. 1D), where the total number (eight) of phase shifters PS equals the total number of columns 120. The antenna 400 may thus have fewer phase shifters PS than the antenna 200 of FIG. 2B. Moreover, in other embodiments, the total number of phase shifters PS may be different from the total number (e.g., six or twelve) of columns 120. Any example of a number of columns discussed in U.S. patent application Ser. No. 17/149,187, filed on Jan. 14, 2021, may be used with the antennas 200, 300, 400.

As with the antenna 300, each phase shifter PS of the antenna 400 has five outputs that are coupled to five power dividers PD, respectively, that feed five different rows 160, respectively, of groups 122 of radiating elements 130 (FIG. 1D). As shown in FIG. 4A, the first phase shifter PS-1 is coupled to the first power-divider PD-1, the ninth power divider PD-9), the seventeenth power divider PD-17, the twenty-fifth power divider PD-25, and the thirty-third power divider PD-33, each of which may be coupled to a respective row 160. For example, the thirty-third power divider PD-33 may be coupled to respective groups 122 of radiating elements 130 in the non-adjacent columns 120-1 and 120-5, where the coupled groups 122 are in the same row 160.

For simplicity of illustration, outputs of the second through eighth phase shifters PS-2 through PS-8, as well as connections from the first through thirty-second and thirty-fourth through fortieth power dividers PD-1 through PD-32 and PD-34 through PD-40 to the columns 120, are omitted from view in FIG. 4A. In some embodiments, first and second groups of the power dividers PD may comprise twenty first-polarization power dividers PD and twenty second-polarization power dividers PD, respectively, where the first and second polarizations are different polarizations. For example, the thirty-seventh power divider PD-37 may, like the thirty-third power divider PD-33, be coupled to the non-adjacent columns 120-1 and 120-5, and these two power dividers PD-33 and PD-37 may be different-polarization power dividers.

FIG. 4B is a schematic block diagram of the power dividers PD and columns 120 of FIG. 4A on a shared power-divider board 410. All forty power dividers PD-1 through PD-40 of the antenna 400 share the same board 410. The antenna 300 of FIG. 3A, by contrast, divides the forty power dividers PD-1 through PD-40 among five sub-array power-divider boards 310-1 through 310-5.

The shared board 410 is on a front surface 170F of a reflector 170 of the antenna 400, whereas the boards 310-1 through 310-5 are on the rear surface 170R (FIG. 3A) of the reflector 170 of the antenna 300. The phase shifters PS (FIG. 4A) of the antenna 400, like the phase shifters PS of the antenna 300, are on a rear surface 170R of the reflector 170. The columns 120, which are on the front surface 170F, may also be on the shared board 410. Specifically, the eight columns 120 and five rows 160 of radiating elements 130 that are shown in FIG. 1D may all be integrated with the forty power dividers PD-1 through PD-40 on the shared board 410. In some embodiments, the boards 310 and 410 may be PCBs, such as feed-board PCBs.

Antennas according to embodiments of the present invention may provide a number of advantages. For example, referring to FIG. 2B, a calibration board 210 of an antenna 200 (FIG. 2A) may include power dividers PD thereon. By integrating the power dividers PD with the calibration board 210, cables and solder transitions that would otherwise connect the power dividers PD to a separate calibration board may be eliminated. As a result, the antenna 200 may have reduced losses, increased gain, and improved passive intermodulation (“PIM”) distortion relative to those of a conventional antenna. The antenna 200 may also be less expensive than the conventional antenna, as materials (e.g., cables, plates, and/or studs) and labor (e.g., soldering of joints) may be reduced. Further, integrating the power dividers PD on the calibration board 210 may increase the availability of space on the rear surface 170R (FIG. 2A) of the reflector 170 of the antenna 200. This increased space may be used to position phase shifters PS closer to the center of the antenna 200, which can allow a first group of phase cables extending to the bottom of the antenna 200 to be similar in length to a second group of phase cables extending to the top of the antenna 200, thereby improving performance with respect to RF signals transmitted via the phase cables.

As another example, referring to FIGS. 3A and 3B, power dividers PD of an antenna 300 may be coupled between phase shifters PS and columns 120 of radiating elements 130 (FIG. 1D). Specifically, the power dividers PD may be on a plurality of sub-array power-divider boards 310 that are on the rear surface 170R of the reflector 170 of the antenna 300. As a result, the total number of phase shifters PS in the antenna 300 may be reduced (e.g., halved) relative to the antenna 200 (FIG. 2A). The depth of the antenna 300 may also be reduced.

In a further example, referring to FIGS. 4A and 4B, power dividers PD of an antenna 400, like those of the antenna 300 of FIGS. 3A and 3B, may be coupled between phase shifters PS and columns 120 of radiating elements 130. As a result, the total number of phase shifters PS in the antenna 400, as well as the depth of the antenna 400, may be reduced relative to the antenna 200 (FIG. 2A). Moreover, unlike the antenna 300, the power dividers PD of the antenna 400 may be integrated with the columns 120 on a shared board 410 (FIG. 4B) that is on the front surface 170F of the reflector 170 of the antenna 400. The antenna 400) may thus be less expensive than the antenna 300, as the number of soldering joints may be reduced. The shared board 410, however, may be larger than any PCB of the antenna 300.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e, “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

That which is claimed is:

1. A base station antenna comprising:
a reflector:
a plurality of radiating elements that are in a plurality of rows and columns on the reflector, each of the radiating elements extending forwardly from a first side of the reflector;
a calibration port; and
a calibration board on a second side of the reflector that is opposite the first side, wherein the calibration board comprises a plurality of power dividers that are each coupled to the calibration port, a first of the power dividers being coupled to a pair of the columns.

2. The base station antenna of claim 1, wherein the calibration board further comprises a plurality of directional couplers that are coupled to the power dividers without any cables therebetween.

3. The base station antenna of claim 2, wherein a first of the directional couplers is coupled to an input of the first of the power dividers.

4. The base station antenna of claim 2, wherein the directional couplers and the power dividers comprise traces of the calibration board.

5. The base station antenna of claim 1, wherein the pair of the columns comprises a non-adjacent pair of the columns.

6. The base station antenna of claim 1, further comprising a plurality of phase shifters on the second side of the reflector,
wherein the first of the power dividers is coupled to the pair of the columns via a pair of the phase shifters.

7. The base station antenna of claim 1, wherein the first of the power dividers is configured to provide a plurality of unequal power outputs.

8. The base station antenna of claim 1, further comprising:
a first-polarization RF port that is coupled to the pair of the columns via the first of the power dividers; and
a second-polarization RF port that is coupled to the pair of the columns via a second of the power dividers.

9. A base station antenna comprising:
a reflector:
a plurality of radiating elements that are in a plurality of rows and columns on the reflector, each of the radiating elements extending forwardly from a first side of the reflector;
a plurality of phase shifters; and
a printed circuit board (PCB) on a second side of the reflector that is opposite the first side, wherein the PCB comprises a plurality of power dividers that are coupled between the phase shifters and the columns, a first of the power dividers being coupled between a first of the phase shifters and a pair of the columns.

10. The base station antenna of claim 9,
wherein the PCB comprises a first PCB that is coupled to a first of the rows, and
wherein the base station antenna further comprises a second PCB on the second side of the reflector, the second PCB comprising a plurality of power dividers that are coupled to a second of the rows.

11. The base station antenna of claim 10, further comprising a third PCB on the second side of the reflector, the third PCB comprising a plurality of power dividers that are coupled to a third of the rows.

12. The base station antenna of claim 11, further comprising a fourth PCB on the second side of the reflector, the fourth PCB comprising a plurality of power dividers that are coupled to a fourth of the rows.

13. The base station antenna of claim 12, further comprising a fifth PCB on the second side of the reflector, the fifth PCB comprising a plurality of power dividers that are coupled to a fifth of the rows.

14. The base station antenna of claim 9,
wherein each row comprises a plurality of feed-board PCBs, each of the feed-board PCBs having one or more of the radiating elements thereon, and
wherein the first of the power dividers is configured to provide a plurality of unequal power outputs.

15. The base station antenna of claim 9,
wherein the phase shifters comprise first-polarization phase shifters and second-polarization phase shifters on the second side of the reflector,
wherein the first of the phase shifters is a first of the first-polarization phase shifters, and
wherein a second of the power dividers is coupled between the pair of the columns and a first of the second-polarization phase shifters.

16. The base station antenna of claim 15, wherein a total number of the phase shifters is equal to a total number of the columns.

17. A base station antenna comprising:
a reflector:
a printed circuit board (PCB) on a first side of the reflector:
a plurality of radiating elements that are in a plurality of rows and columns on the PCB, each of the radiating elements extending forwardly from the PCB; and
a plurality of phase shifters, wherein the PCB comprises a plurality of power dividers that are coupled between the phase shifters and the columns, a first of the power dividers being coupled between a first of the phase shifters and a pair of the columns.

18. The base station antenna of claim 17,
wherein the phase shifters comprise first-polarization phase shifters and second-polarization phase shifters on a second side of the reflector that is opposite the first side,
wherein the first of the phase shifters is a first of the first-polarization phase shifters, and
wherein a second of the power dividers is coupled between the pair of the columns and a first of the second-polarization phase shifters.

19. The base station antenna of claim 18, wherein a total number of the phase shifters is equal to a total number of the columns.

20. The base station antenna of claim 17,
wherein the rows and columns comprise five rows and eight columns, respectively, that are on the PCB,
wherein the first of the power dividers is configured to provide a plurality of unequal power outputs, and
wherein a second of the power dividers is configured to divide power at a ratio different from that of the first of the power dividers.
